(19) United States
(12) Patent Application Publication
(10) Pub. No.: US 2018/0247030 A1
(43) Pub. Date: Aug. 30, 2018

(54) Medical Reconciliation Standardization

(71) Applicant: Brian Dorsey, Emporia, KS (US)

(72) Inventor: Brian Dorsey, Emporia, KS (US)

(21) Appl. No.: 15/443,567

(22) Filed: Feb. 27, 2017

(51) Int. Cl. G06F 19/00

(52) U.S. Cl. CPC G06F 19/3456; G06F 19/328; G06F 19/322; G06F 19/3406

(57) ABSTRACT

A computer-implemented system and method to improve patient care throughout the hospital continuum by creating a complete and accurate list of a patient's past and current medications and other treatment-related information are disclosed. The present system can be employed to review and compare the past and present medication records of the patients to provide them better care and treatment. The system includes a server running a medical reconciliation application having a number of modules including clinical and pharmacy information management modules for managing clinical and medication information of the patients. The system further includes a number of electronic devices in communication with the server for allowing the users to access the clinical and medication information of the patients. The present system provides a standardized comprehensive clinical and medication reconciliation process for the patients through an interactive user interface of the medical reconciliation application accessible through the electronic devices.

### (A) CROSS REFERENCE TO RELATED APPLICATIONS

Not applicable

### (C) FEDERALLY SPONSORED RESEARCH AND DEVELOPMENT

Not applicable.

### (D) MICROFICHE

Not applicable

### (E) BACKGROUND OF THE INVENTION

### (1) Field of the Invention

The present invention is directed to a computer-implemented system and method to improve patient care throughout the hospital continuum. More specifically, the present invention is directed to a computer-implemented system for comprehensive clinical and medication reconciliation of a number of patients.

### (2) Background of the Invention

A patient can receive various medical treatments to treat a disease or a medical condition. Medical care can include prescribing a medication that must be taken by the patient for one or more medical conditions in prescribed doses at certain intervals over the course of a treatment period. For some patients, the complexity of their medication list can increase over time. For example, during the course of treatment, the medical professional can change a prescribed medication with a replacement medication, add one or more additional medications, or alter the dosing of a currently prescribed medication. Also, other medical professionals caring for the patient can prescribe other medications for treating other conditions. The number of medications a patient has for active and inactive prescriptions can accumulate over time. Additionally, the patient can also purchase over-the-counter medicines. Under these and other circumstances, managing patient's medication data can become difficult.

A Joint Commission on Accreditation of Healthcare Organizations (JCAHO) Patient Safety Goal requires healthcare providers to accurately and completely reconcile medications and treatments across the continuum of care during the care of a patient. Medication reconciliation comprises taking a patient's home medication list including medications prior to admission and comparing it to the patient's current active medication orders or, in the case of admission, this may be the medications being considered for ordering, to create a new medication list upon admission or the next care setting or a discharge medication list for a patient to use at home. Known reconciliation systems are typically either fully paper-based, a paper plus electronic hybrid, or a standalone electronic system. The paper/electronic model involves printing a list of medications and then manually reconciling them on paper. Known systems that are entirely paper-based require a user to retrieve and/or transcribe lists of a patient's home medications and active medications. Such systems suffer from being time-consuming, prone to transcription errors, prone to errors in medication prescribing as well as legibility errors. Systems that are a paper-electronic hybrid, which includes handwritten medication orders regardless of implementation, are prone to the same errors but to a lesser degree depending on how much information is generated and printed. Standalone systems are not integrated, so any medication list produced needs to be re-entered into the hospital information system if an electronic record is desired.

An Electronic Medical Record (EMR) is a database record or other data structure that is used by hospitals and other health care facilities to store current information about patients. Ideally, all information about the patient is stored within the patient's EMR, thereby eliminating the need for traditional paper files. Within an EMR system used by a particular health care facility, each patient has his or her own EMR for storing both current and historical information about the patient. Some of the data stored within a particular EMR may be divided into discrete fields, such as a “First Name” field, a “Last Name” field, a “Date of Birth” field, “Medications,” “Allergens,” and so on. To store information in an EMR, the EMR system typically displays an on-screen form in which the name of each field is displayed adjacent to a blank space. A healthcare worker types the appropriate information into the blank space associated with each field. Although other user interface elements, such as checkboxes and drop-down lists, may facilitate the act of entering data into an EMR, the data entry process still essentially involves manually entering data into discrete fields in the EMR. This process can be tedious, time-consuming, and error-prone. Despite these problems, many EMR forms are filled out correctly and completely when they are first created. More problematic is the process of keeping EMRs up to date as the information associated with the corresponding patient changes. Ideally, as a patient's diagnosis, prognosis, treatments, and personal information changes, such updated information would be entered into the patient's EMR quickly, accurately, and completely. Several prior patents disclose similar computer assisted systems and method for managing the patient information and the medication information of the patients. The following prior art patents are herein incorporated by reference for their supportive teachings.

U.S. Pat. No. 8,249,897 B2 issued to Medimpact Healthcare Systems, Inc. discloses systems, methods, and techniques for presenting a medication list to a patient and for maintaining updates to the medication list. The systems, methods, and techniques disclosed in the above-cited patent can determine an up-to-date medication list for the patient. The above systems, methods and techniques can also allow a patient to keep a patient medication list updated over time and to address problems that arise as medications are changed or added. However, the above systems and methods do not offer a comprehensive clinical and medication reconciliation platform for managing the medication list of the patients quickly, accurately and completely and to improve patient care throughout the hospital continuum.

U.S. Pat. No. 8,725,539 B2 issued to Premier Health Care Services Inc. discloses systems and methods for providing a continuum of care to the patients. The system includes a memory component that stores a program that, when executed by the system, causes the system to receive patient information for a patient. The patient information includes medical information of the patient suffering from a specific medical condition. The program causes the system to receive data for a primary patient screening to determine whether the patient has a tangential medical condition and, in response to determining that the patient has the tangential medical condition, receive data for a secondary patient screening to determine an extent of the tangential medical condition. The program causes the system to create a continuum of care plan for the patient that utilizes the patient information and results of the primary screening to predict a future medical attention need of the patient, where the continuum of care plan coordinates patient care with a number of different health care providers. However, the above systems and methods do not offer a comprehensive clinical and medication reconciliation platform for managing the medication list of the patients quickly, accurately and comprehensively and to improve patient care throughout the hospital continuum.

Another prior art U.S. Pat. No. 9,305,030 B2 issued to Med-Legal Technologies, Llc discloses a records management system and method that permits paper records to be tagged, stored and retrieved according to user criteria. The system includes a scanning module, a central server, one or more user workstations and an optical character recognition server. After scanning, the records may then be serialized and categorized by project, and then supplemented automatically by the system with a hypertext data file. The system provides for the manual input of additional hypertext data and merger of the hypertext data file with other records in the project. The end user may then search and/or filter records according to information contained in the hypertext data file. The output from the system may include summary excerpts whereby summaries for data contained in select pages of each document in a project are associated with at least dates, page numbers, and providers for the data. However, the above patent does not disclose a means for clinical and medication reconciliation of the patients and thereby to improve the patient care throughout the hospital continuum.

Hence there exists a need for a comprehensive clinical and medication reconciliation platform for managing the medication list of the patients quickly, accurately, completely and thereby to improve patient care throughout the hospital continuum.

### (F) SUMMARY OF THE INVENTION

The present invention relates to a computer-implemented system and method to improve patient care throughout the hospital continuum by creating a complete and accurate list of a patient's past and current medications and other treatment related information, such as; patient correlated problems, immunizations records, and primary retail pharmacy information. The present computer-implemented system can be employed to review and compare the past and current medication records of the patients to provide them better care and treatment. The system includes a server running a medical reconciliation application having a number of modules including clinical and pharmacy information management modules for managing clinical and medication information of the patients. The system further includes a number of electronic devices in communication with the server for allowing the users to access the clinical and medication information of the patients. The present system provides a standardized comprehensive clinical and medication reconciliation process for the patients through an interactive user interface of the medical reconciliation application accessible through the electronic devices.

In accordance with the present invention, there is provided a computer-implemented system for comprehensive clinical and medication reconciliation of a number of patients. Further, the computer-implemented system includes a medical reconciliation application accessible by both medical reconciliation technicians, registered nurses, and pharmacists to manage the medical reconciliation of each of the patients visiting a medical facility as well as their dismissal from a medical care facility.

It is another feature of the present invention is to provide a computer-implemented system having a medical reconciliation application to improve the patient experience and to improve the HCAHPS score.

It is a further feature of the present invention is to provide a medical reconciliation application to manage the past and current medication list of the patients and the hospital records of each of the patients and thereby improving the various healthcare and Medicaid services, thus allowing faster and easier Medicare and Medicaid reimbursements for meaningful use to the care facility.

It is a further feature of the present invention is to provide a comprehensive clinical and medication reconciliation of the patients in the inpatient and emergency departments that make the medication and associated treatments processes for each of the patients more efficient, provides quick and accurate information on patient charts, allows the patients or other associated users to observe recent modifications to a medication list and therefore informs any medical personel of these changes to a medication list, thereby allowing a physician to treat systematically and stabilize acutely illed patients where if admitted, the primary physician can order the home medicines quickly and accurately through the medical reconciliation application associated with the present system.

It is a further feature of the present invention is to provide a computer-assisted system for comprehensive clinical and medication reconciliation that allows the patients to understand and follow as directed all current prescribed medications, as well as, over the counter, supplements, as needed medications and other related information themselves through the medical reconciliation application.

Another feature of the present invention is to provide the medical reconciliation application running on the server and accessible from the electronic devices to ensure proper pharmacotherapy of the patients and to minimize the prescribing errors.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### (G) BRIEF DESCRIPTION OF THE DRAWINGS

To further clarify various aspects of some example embodiments of the present invention, a more particular description of the invention will be rendered by reference to specific embodiments thereof that are illustrated in the appended drawing. It is appreciated that the drawing depicts only illustrated embodiments of the invention and are therefore not to be considered limiting of its scope. Elements in the figures have not necessarily been drawn to scale in order to enhance their clarity and improve understanding of these various elements and embodiments of the invention. Furthermore, elements that are known to be common and well understood to those in the industry are not depicted to provide a clear view of the various embodiments of the invention. Thus, the drawings are generalized in the form in the interest of clarity and conciseness. The invention will be described and explained with additional specificity and detail through the use of the accompanying drawing in which:

FIG. 1 is a block diagram showing the present computer-implemented system for comprehensive clinical and medication reconciliation of the patients, according to a preferred embodiment of the present invention;

FIG. 2 is a block diagram showing the different components and modules of the electronic device used for launching the medical reconciliation application, according to a preferred embodiment of the present invention;

FIG. 3 is a block diagram showing the different components and modules of the server running the medical reconciliation application and in communication with the electronic devices at the user's end, according to a preferred embodiment of the present invention;

FIG. 4 is a flowchart showing the steps for performing the medication reconciliation of the patient, according to a preferred embodiment of the present invention; and

FIG. 5 is a flowchart showing the steps for performing the medication reconciliation of the patient, according to a preferred embodiment of the present invention.

### (H) DETAILED DESCRIPTION OF THE INVENTION

In the following detailed description, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural and logical changes may be made without departing from the spirit and scope of the present invention. The following detailed description is, therefore, not to be taken in a limiting sense, and the scope of the present invention is defined by the appended claims and their equivalents.

The present invention relates to a computer-assisted system and method to improve patient care throughout the hospital continuum by creating a complete and accurate list of a patient's past and current medications and other treatment related information. The present computer-assisted system can be employed to review and compare the past and present medication records of the patients to provide better care and treatment to the patients.

The present computer-assisted system enables the medical personnel or the pharmacists to avoid medication errors such as, but not limited to, omissions, duplications, dosing errors, allergic medicine prescriptions or drug interactions. Further, the present computer-assisted system enables the medical personnel or the pharmacists to address all above-discussed issues through a medical reconciliation application associated with the present computer-assisted system. In addition, the present computer-assisted system can be utilized to effectively standardize the medical reconciliation process at any level or department or level of care of a hospital. The present computer-assisted system allows the medical personnel or the pharmacists to review the past and present medication records of the patients, including inpatients, patients under observation and patients admitted to the emergency care departments. In addition, the present computer-assisted system also assists the medical personnel or the pharmacists to provide accurate medication orders in case when the patient is changed from one level of treatment to another such as from ICU to acute or acute to skilled and acute or skilled to inpatient rehabilitation changes.

The present computer-assisted system for comprehensive clinical and medication reconciliation of the patients in the inpatient and emergency departments makes the medication and associated treatments processes for each of the patients more efficient, provides quick and accurate information on patient charts, allows the patients or other associated users to order the home medicines quickly and accurately through the medical reconciliation application associated with the present system. This, in turn, allows the nurses to provide direct patient care and thereby improves the overall quality of service provided by the clinics and the pharmacies. Further, the present computer-assisted system for comprehensive clinical and medication reconciliation allows the physician to manage all the medication and other related information themselves through the medical reconciliation application. The present computer-assisted system for comprehensive clinical and medication reconciliation of the patients employs a step-by-step approach and updates the patients' electronic medical record in a particular order involving information to and from physician(s), health care personnel, or specialist(s), medical claim history, pharmacy information, and patient verbal report and/or medication list. This information can be updated in the medical reconciliation application completing the clinical and medication information of the patients through the present computer-assisted system. Further, the present computer-assisted system can be utilized by the patients and the healthcare personnel to receive information about healthcare information, problems list, immunizations, allergies, and pharmacy related information, such as the primary retial pharmacy, mail order, etc. Further, other related information can be obtained, including the number of refills on medications, quantity of tablets and number of days. This, in thurn, allows a medical practitioner or the medical personnel to prepare a best possible medication list for the patient by referring all the information available through an interactive user interface of the medical reconciliation application associated with the present computer-assisted system.

The present computer-assisted system for comprehensive clinical and medication reconciliation will improve the patient outcomes as well as their experiences, thereby helping to improve the HCAHPS (the Hospital Consumer Assessment of Healthcare Providers and Systems) score, which is a patient satisfaction survey required by CMS (the Centers for Medicare and Medicaid Services) for all hospitals in the United States, and the system also supports similar healthcare and Medicaid services of other countries. Utilizing the present computer-assisted system for comprehensive clinical and medication reconciliation allows the patients to receive an optimal medical reconciliation completion rate compared to other existing hospital information systems. This, in turn, allows a care facility to receive under current CMS guidelines maximum federal reimbursements.

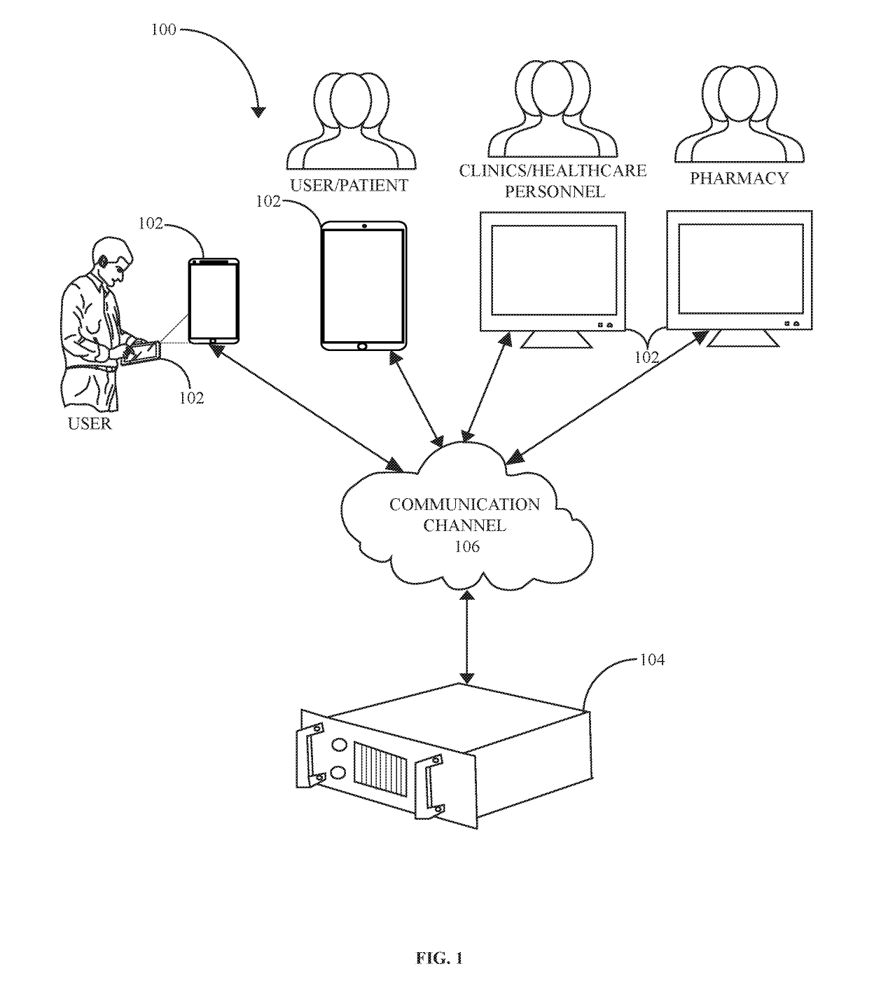

FIG. 1 is a block diagram showing the present computer implemented system 100 for comprehensive clinical and medication reconciliation of the patients, according to a preferred embodiment of the present invention. The computer implemented system 100 for comprehensive clinical and medication reconciliation of the patients includes a server 104 running a medical reconciliation application for providing a variety of comprehensive clinical and medication reconciliation services to the patients and the medical personnel and other pharmacies and clinics. The medical reconciliation application includes a number of modules for managing a variety of clinical and medication information of the patients. These modules of the medical reconciliation application contain a clinical information management module for managing communications with a number of clinics visited by the patient, a pharmacy management module for managing communications with a number of pharmacies from where the patient has received or purchased medicines and other medical aids and a payment module for enabling online transactions with the clinics and the pharmacies. The medical reconciliation application running on the server 104 further includes additional modules, which are explained in detail in the below-detailed description sections. The present computer-implemented system 100 for comprehensive clinical and medication reconciliation of the patients further includes a number of electronic devices 102 in communication with the server 104 for allowing the users including the patients and other personnel at the clinics, medical personnel and other pharmacy personnel to access the clinical and medication information of the patients through the medical reconciliation application running on the server 104 and accessed through the electronic devices 102. The interactions between the server 104 and the electronic devices 102 are performed through a communication channel 106 such as, but not limited to the wireless communication means such as Wi-Fi, Wimax and other data communication methods providing internet services. The present computer-implemented system 100 provides a standardized comprehensive clinical and medication reconciliation process for the patients through an interactive user interface of the medical reconciliation application accessible from the electronic devices 102. The users or the patients can access the medical reconciliation application from their personal devices or through conventional devices such as office computer or any other devices connected to the internet and capable of launching the interactive user interface of the medical reconciliation application.

The medical reconciliation application running on the server 104 collects and stores a number of past and present clinical and medication information of the patients. The clinical information management module of the medical reconciliation application manages the past, and present communications with the clinics and clinical records of the patients and the pharmacy management module manages the past and present communications with the pharmacies and the medication records of the patients. Further, the medical reconciliation application running on the server enables the patients to receive accurate treatment continuum from the clinics and the pharmacies based on the past and present clinical and medication information of the patients. The pharmacy management module of the medical reconciliation application allows the pharmacies to deliver medications to the patients before hospital discharge. In addition, the pharmacy management module of the medical reconciliation application enables the pharmacies to communicate with the patients through audio and video chats. In some instance, the medical reconciliation application includes a payment module that allows the users to perform the online transactions with the clinics and the pharmacies. The medical reconciliation application running on the server 104 provides a number of profiles for each of the users including patient profile, family profile, caretaker profile and a plurality of user defined profiles for managing a plurality of features of the medical reconciliation application. The medical reconciliation application running on the server 104 communicates with third party services including healthcare insurance services for managing healthcare insurance related information of the patients. The medical reconciliation application accessible from the electronic devices 102 is in communication with the server 104 and allows the users to manage the clinical and medication information including dosage information and drug availability information for the patients. Further, the medical reconciliation application running on the server 104 and accessible from the electronic devices 102 allows the users to receive a variety of disease-related information of the patients through its interactive user interface and also receives alerts to the patients for medication and related activities. Further, the medical reconciliation application running on the server and accessible from the electronic devices ensures proper pharmacotherapy of the patients and minimizes the prescribing errors.

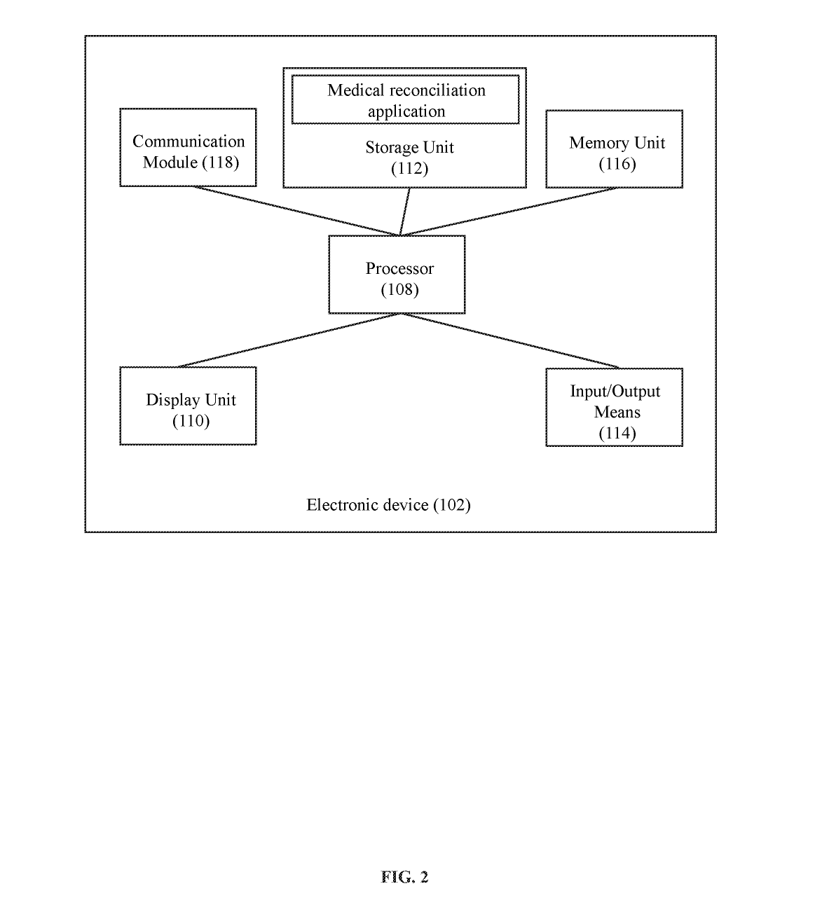

The hardware and software components of the present computer implemented system 100 are discussed in detail below prior to disclosing the unique features and services offered by one or more embodiment of the present system 100. FIG. 2 is a block diagram showing the different components and modules of the electronic device 102 used for launching the medical reconciliation application, according to a preferred embodiment of the present invention. The electronic device 102 can be smart devices such as, but not limited to, a smartphone, tablet, computer, smart wearable devices, and other smart devices connected to the Internet and capable of displaying the interactive graphical user interface (GUI) of the medical reconciliation application. The electronic device 102 includes a processor 108 to process a number of instructions of the medical reconciliation application, a display means 110 for displaying the interactive graphical user interface of the medical reconciliation application, a storage unit 112 for storing a variety of data associated with the medical reconciliation application, an input/output means 114 for allowing the users to interact with the interactive graphical user interface of the medical reconciliation application, a memory unit 116 for temporarily storing the data and instructions associated with the medical reconciliation application while performing a number of operations by the processor 108 and a communication module 118 to enable communication between the electronic devices 102 and the server 104 via the wireless communication channel 106. The users including the patients and other authorized personnel at the clinics, medical personnel, and other pharmacy personnel are allowed to interact with the contents of the medical reconciliation application through the interactive graphical user interface of the medical reconciliation application using the input/output means 114 of the electronic devices 102. For instance, the users are allowed to interact with the contents presented on the interactive graphical user interface of the medical reconciliation application using a keyboard, pointing device such as a mouse, at least one gesture or touch, voice activation, or any other interacting means. The medical reconciliation application includes optional features that allow the electronic devices 102 to launch a camera module to capture the contents including images and videos, for example, images of medicines and medical prescriptions, and stores the captured contents in the medical reconciliation application. Further, the input/output means 114 allows the users to provide additional information such as the medical reconciliation including healthcare insurance related information, and other medical reimbursement related information through the interactive graphical user interface of the medical reconciliation application.

The processor 108 associated with the electronic device 102 processes a number of instructions of the medical reconciliation application to allow the users to manage and monitor the progress of the patient's treatment, prescriptions, and other related information of the patient. The processor 108 further executes the instructions of the medical reconciliation application to allow the users to provide a variety of information such as medical information, patient's medication-related past and present information, insurance related information, etc. In a preferred embodiment of the present invention, the display means 110 is a touchscreen display and is capable of displaying the interactive graphical user interface of the medical reconciliation application to allow the users to view, edit, or provide the variety of information such as medical information, patient's medication-related past and present information, insurance related information, etc.

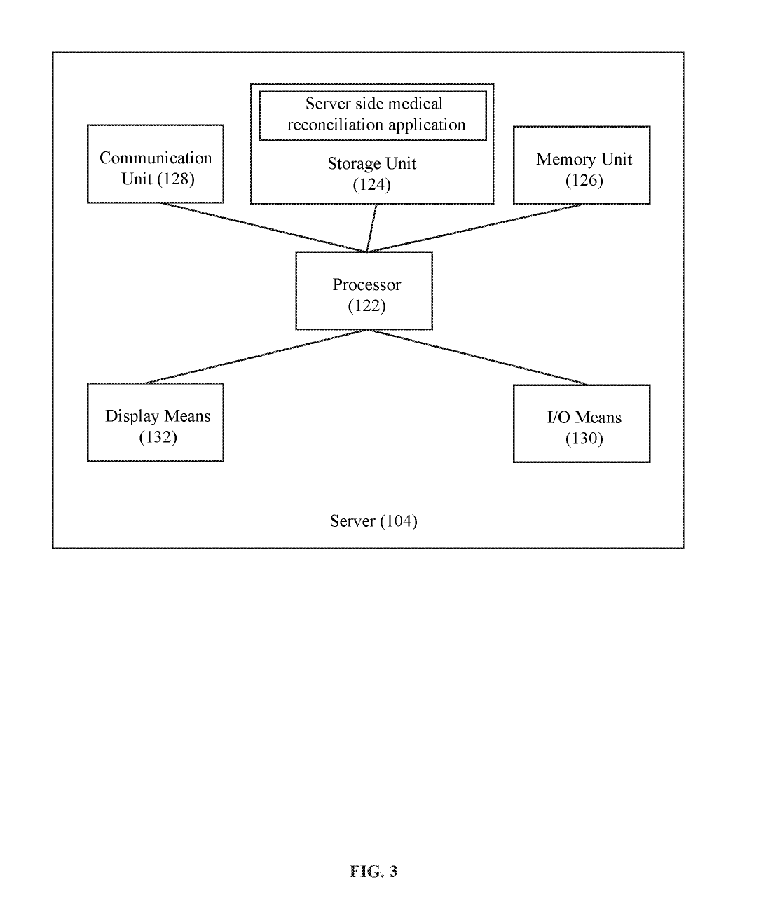

According to a preferred embodiment of the present computer implemented system 100, all the communication between the medical reconciliation application accessed from the electronic devices 102 of the users and the server 104 running the medical reconciliation application are performed over the wireless communication channel 106. The server 104 can be a physical server 104 located at one or more locations or a central cloud server 104 offering services to the users via the medical reconciliation application connected to the central cloud server 104. FIG. 3 is a block diagram showing the different components and modules of the server 104 running the medical reconciliation application and in communication with the electronic devices 102 at the user end, according to a preferred embodiment of the present invention. The server 104 includes similar components as any normal server or a computer, which includes a processor 122, a storage unit 124, a memory unit 126, a communication unit 128, an input/output (I/O) means 130 and a display means 132. The server 104 is in communication with the electronic devices 102 in real-time over the Internet enabled by the communication unit 128. In some instances, the server 104 is installed with a server side medical reconciliation application configured to manage the operations of the client-side medical reconciliation application running on the electronic devices 102. The medical reconciliation application is stored in the storage unit 124 and the processor 122, when required, executes the instructions of the application to perform a number of tasks including user management, comprehensive clinical and medication reconciliation of the patients, etc. The memory unit 126 stores the data associated with the medical reconciliation application when the processor 122 executes the instructions of the application. The medical reconciliation application includes a user management module that handles all the information related to the user registration and all other user-related activities performed by the users through the interactive graphical user interface of the medical reconciliation application launched or accessed on their electronic devices 102. The medical reconciliation application running on the server 104 further includes a content management module that receives and temporarily or permanently stores the contents received from or presented through the interactive graphical user interface of the medical reconciliation application launched or accessed from the electronic devices 102.

In some instance, the medical reconciliation application is made available to the users as software packages, which they can purchase and install on the electronic devices 102. In some other instance, the medical reconciliation application is provided as a web application that communicates with the medical reconciliation application running on the server 104. In some other instances, the present medical reconciliation application is provided to the users as a mobile application and the users can download the medical reconciliation application from Internet sources including, but not limited to, iTunes store or App store, Google play store and many other software stores and install the application in their electronic devices 102 such as Smartphones. In some instance, different versions of the medical reconciliation application are available from the Internet sources, which includes a web application, computer software application and a smart device application, each version is configured to optimally run on different electronic devices 102 such as tablet, computer, smartphone, smart wearable devices, etc., and the users can select and download the desired versions of the medical reconciliation application into their electronic device 102. After downloading and installing the medical reconciliation application, the users can launch the application from the electronic device 102 and view the interactive graphical user interface of the medical reconciliation application, which allows the users to perform a number of tasks such as, but not limited to, user registration, view, edit, or provide the variety of information such as medical information, patient's medication past and present related information, insurance related information, etc.

The present computer-assisted method for comprehensive clinical and medication reconciliation of a patient starts with the step of collecting a variety of clinical and medication related information of the patients. The information is gathered from the patients during medical reconciliation interviews, which can be either face-to-face interview or through any communication medium with a medical reconciliation technician. The medical reconciliation technician collects all the required information including the clinical information and the past and present medication list or medication information of the patient for all inpatient and emergency care admissions. Further, the medical reconciliation technician enters all the collected details in the medical reconciliation application, which is running on the server 104 and accessed from the electronic devices 102 at the end of the medical reconciliation technician, through the interactive user interface. The medical reconciliation technician identifies patients with high risk of medication problems and prioritizes those patients based on possible high-risk criteria. Further, the medical reconciliation technician identifies any non-compliance issues with the admitted patient's medical regimen and enables him/her to report it to the pharmacist or any other attending provider through the medical reconciliation application or through other communication means. In addition, the present medical reconciliation application assists the medical reconciliation technician to report any non-compliance issues' or dates of past office or clinic or emergency care visits to the attending physician or the medical personnel of the patient. In short, the present computer-implemented system and associated method helps to improve patient care throughout the hospital continuum in regards to creating the most complete and accurate list of a patient's current medications and also assists in comparing an established medication list of the patient to those active in a patient record or medication orders. This, in turn, helps to avoid medication errors, such as omissions, duplications, dosing errors, or drug interactions.

The method of collecting the past and the present medication history of a patient includes several steps as discussed below. The present method helps to achieve the best possible medication history of the patient efficiently and accurately. The present method further clarifies and improves consistency and accuracy in the documentation of home medication of the patient and keeps track of the changes in the home medication through the medication reconciliation application. The method starts with the face-to-face interview or question answer session by the authorized personnel. The below steps explain how to perform the medical reconciliation of the patient, according to an embodiment of the present invention. When a patient enters the emergency department or placed in either “Inpatient” or “Observation” status, a Medication Reconciliation Technician (MRT) or the Registered Nurse (RN) performs reconciliation of the patient's home medications. This is usually performed within 12 hours of admission of the patient. The registered nurse performs the reconciliation operation when the medication reconciliation technician is not available, and the medication reconciliation technician re-evaluates the records collected by the registered nurse during scheduled hours. However, with the current implemented process, a medical reconciliation technician can perform reconciliation and finish an electronic record within 20 minutes. In addition, upon admission and discharge from an emergency room, a medication reconciliation technician will perform a medical reconciliation for each outgoing patient(s) utilizing the medical reconciliation application accessed through the electronic device 102 at their ends. Also, a MRT will utilize the same process by performing reconciliation through same day surgery.

The medication history of the patient may be obtained verbally from an alert patient or from a reliable source such as, but not limited to, pharmacy, caregiver, a list of medications provided by the patient, prescription containers, med-claim history, nursing home records, and/or information obtained from a history and physical (H and P) record of the clinic and/or specialist. Any history obtained within the last three months of a physician history and physical (H and P) may be used to gather accurate information regarding the ‘Home Medication’ use of the patient. All the information obtained from the various sources are verified by the patient and/or reliable source(s) prior to entering into the medical reconciliation application running on the server 104 and accessed through the electronic device 102. In some instances, the medical reconciliation application allows the users to store a number of source(s) of the medication history of the patient, which can be scanned or an image of the source can be stored in the individual profile of the patient in the medical reconciliation application. Further, the medical reconciliation application allows the users to flag or mark any incomplete or unverified medications list, which allows the medication reconciliation technician, or the registered nurse, or the pharmacist to verify the medications list with flag markings to request review by the attending provider. Thus, all the information including the medication list entered through the medical reconciliation application is verified and updated to reflect the accurate information of each patient.

The present method and associated computer-implemented system for comprehensive clinical and medication reconciliation of the patients enables the hospitals and other medical care facilities to attain presently the minimal accepted criteria for medical reconciliation under CMS guidelines. The present method allows a care facility to attain more than fifty percent medication reconciliation completion rate for each of the patients using the medical reconciliation application. The medical reconciliation technician evaluates all patient profiles and updates the best possible medication history, allergy(s), immunizations, pharmacy information, and problems list during scheduled hours of operation through the interactive user interface of the medical reconciliation application. A registered nurse performs the same duties when the medical reconciliation technician is unavailable.

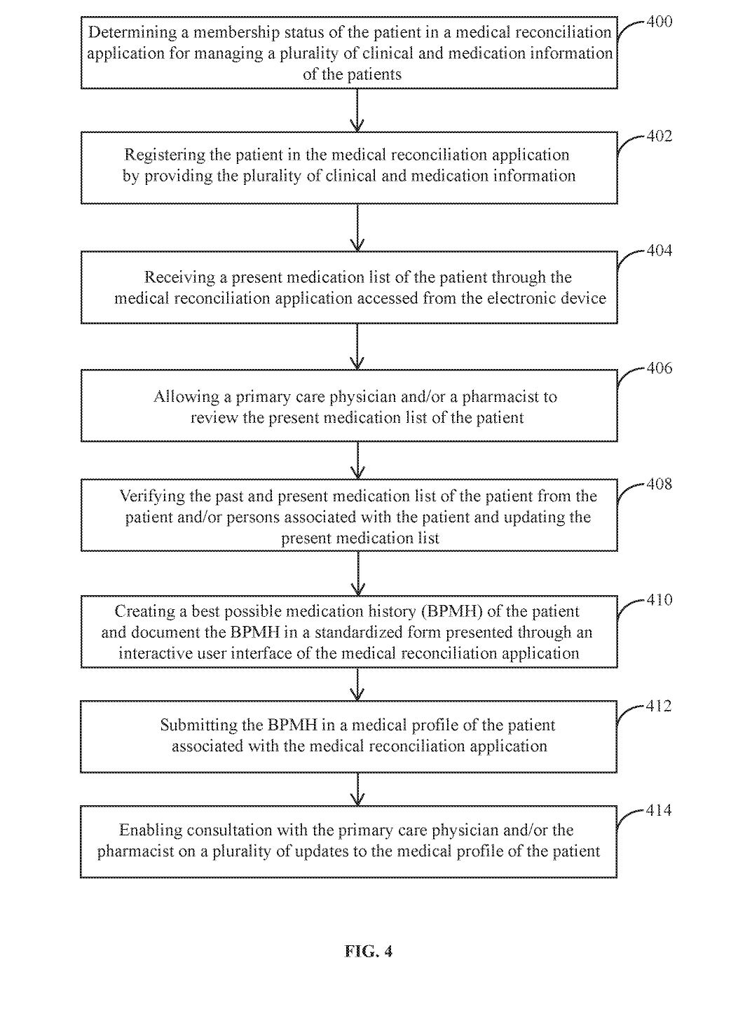

FIG. 4 is a flowchart showing the steps for performing the medication reconciliation of the patient, according to a preferred embodiment of the present invention. The method starts with the step of identifying new patient admissions by the medical reconciliation technician through the medical reconciliation application. From the interactive user interface of the medical reconciliation application, each user such as the medical reconciliation technician or the registered nurse or pharmacist is provided with unique credentials such as unique username and password for logging into the medical reconciliation application. The users can first log in to the medical reconciliation application using the given credentials and can check the new patient admissions and can also verify the incomplete home medicines. At each operating shift at the medical facility or hospital, an emergency department medical reconciliation technician reviews the status board in the medical reconciliation application to identify new patients. The user can verify the membership status of the patient in the medical reconciliation application for managing a variety of clinical and medication information of the patients, as in block 400. Once the user has identified the new patient admissions with incomplete home medicines, the user can send reminders or list of patients and their medication list to respective departments as print outs or notifications through the medical reconciliation application. The user can further take print outs or provide notifications through the medical reconciliation application at periodic intervals. New admissions or new patients into the emergency or inpatient or any other department are registered in the medical reconciliation application. The medical reconciliation technician or registered nurse collects all the past and present medication information from the patient or the aid to the patient or from relatives and enters all the information into the medical reconciliation application launched from the electronic device 102, as in block 402.

The medication history of the patient may be obtained verbally from an alert patient or from a reliable source such as, but not limited to, pharmacy, caregiver, a list of medications provided by the patient, prescription containers, med-claim history, nursing home records, and/or information obtained from a history and physical (H and P) record of the clinic and/or specialist. Any history obtained within the last three months of a physician history and physical (H and P) may be used to gather accurate information regarding the ‘Home Medication’ use of the patient. Once an H and P is obtained, the medical reconciliation technician reviews the patient profile accordingly. The medical reconciliation technician has a general understanding of previous or current diagnosing by attending provider and a possible listed medication changes. The medical reconciliation technician enters the medication list into the medical reconciliation application as directed by each physician and the H and P medication list. The medical reconciliation technician review fills or claims history for assurance and/or confirmation of medications on a profile or additional medications in the medical reconciliation application. The medical reconciliation application allows the medical reconciliation technician to add medications from fill/claim history not presently on H and P medication list, add additional medications to patient profile from a face-to-face interview with the patient, the medications includes oral medications, topical, eye and ear drops, inhalers, injections, sprays, contraceptives, OTC meds, seasonal meds, vitamins, herbals and dietary supplements, etc. Further, the medical reconciliation technician, obtains retail pharmacy information by making a phone call to the pharmacy and obtains information including name of drug, strength of medication and frequency, dosage form, administration instructions and route, additional instructions e.g. duration, tapering dose, written script and also obtain emergency retail pharmacy information and enters the information or verifies the information from the medical reconciliation application. The medical reconciliation technician further checks the allergy reactions of the patients and severity of the allergies. Then the immunizations for each patient are verified with the patients.

The user, such as the medical reconciliation technician, or the registered nurse, or pharmacist, prompts the primary care physician and/or a pharmacist to review the present medication list of the patient as shown in block 404. In some instances, the medical reconciliation application allows the primary care physician and/or the pharmacist to get the present medication list of the patient reviewed from a referring healthcare facility. After obtaining the past and present medication list of the patient, the pharmacist or the medical reconciliation technician or the registered nurse verifies the past and present medication list of the patient from the patient and/or persons associated with the patient and updates the present medication list in the medical reconciliation application. After verifying the past and present medication list of the patient, a best possible medication history (BPMH) of the patient is created using the medical reconciliation application and the user documents the BPMH in a standardized form presented through an interactive user interface of the medical reconciliation application, as shown in block 406. One the BPMH is created, the user can submit the BPMH in a medical profile of the patient associated with the application, as in block 408. Then the user can enable consultation with the primary care physician and/or the pharmacist and discuss the updates to the medical profile of the patient as in block 410.

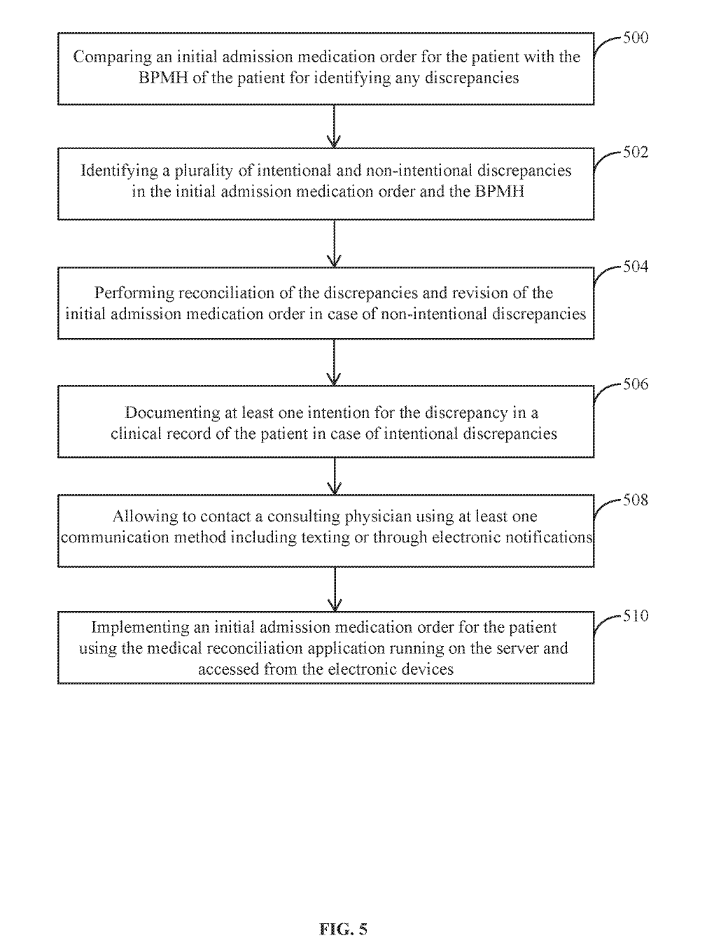

FIG. 5 is a flowchart showing the steps for performing the medication reconciliation of the patient, which succeeds the steps discussed in FIG. 4, according to a preferred embodiment of the present invention. Once the BPMH is updated in the medical reconciliation application, the user, such as the medical reconciliation technician or the registered nurse or pharmacist, compares an initial admission medication order for the patient with the BPMH of the patient for identifying any discrepancies, which is shown in block 500. Then the user can visually identify the intentional and non-intentional discrepancies in the initial admission medication order and the BPMH from the medical reconciliation application, as in block 502. Then the user can perform reconciliation of the discrepancies and revision of the initial admission medication order in case of non-intentional discrepancies, as in block 504. The user documents the intention for the discrepancy in a clinical record of the patient in case of intentional discrepancies, as in block 506. The medical reconciliation application allows the patients to contact a consulting physician using at least one communication method including texting or through electronic notifications, as in block 508. Then the user can implement an initial admission medication order for the patient using the medical reconciliation application running on the server 104 and accessed from the electronic devices 102 at the user's end, as in block 510.

In some instances, the auto-renewal scripts, as well as third party members paying for medication, never completes the discharge paperwork at the pharmacy for updating their system. In the post-discharge paperwork, the patient may “continue,” “start” or “stop” taking certain medications. A physician addresses on the “start” medications as new scripts and sends the new scripts electronically to the patient's retail pharmacy via the medical reconciliation application. Using the present system 100, when a physician addresses those medications in the discharge module, he/she would be able to send e-scripts to the retail pharmacy world to discontinue or “stop” taking medications as well as the scripts to “start” taking. This means, when a physician instructs a patient to stop taking certain medications and hands them paperwork addressing those medications to stop taking those certain medications, those stop medications information are sent and updated in the retail pharmacy network, as well as a fax of the post-discharge list, is sent to the respective departments utilizing the present medication reconciliation application. This eliminates acute care issues and re-admittance of patients who are non-compliant and fail to visit their primary care physician after discharge from the hospital.

Further, it should be noted that the steps described in the method of use can be carried out in many different orders according to user preference. The use of “step of” should not be interpreted as “step for,” in the claims herein and is not intended to invoke the provisions of 35 U.S.C. § 112, (6). Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

We claim:

1. A computer implemented system for comprehensive clinical and medication reconciliation of a plurality of patients comprising:
a. a server running at least one medical reconciliation application having a plurality of modules for managing a plurality of clinical and medication information of the patients;
wherein the plurality of modules of the medical reconciliation application includes:
i). a clinical information management module for managing a plurality of communications with a plurality of clinics;
ii). a pharmacy management module for managing a plurality of communications with a plurality of pharmacies; and
iii). at least one payment module for enabling a plurality of online transactions;
b. a plurality of electronic devices in communication with the server for allowing a plurality of users to access the plurality of clinical and medication information of the patients through the medical reconciliation application running on the server; and
c. a communication channel enabling communication between the electronic devices and the server;
characterized in that the computer-implemented system provides a standardized comprehensive clinical and medication reconciliation process for the plurality of patients through an interactive user interface of the medical reconciliation application accessible through the plurality of electronic devices.

2. The computer-implemented system of claim 1, wherein the medical reconciliation application running on the server collects and stores a plurality of past and present clinical and medication information of the patients.

3. The computer-implemented system of claim 1, wherein the clinical information management module manages a plurality of past and present communications with the clinics and clinical records of the patients.

4. The computer-implemented system of claim 1, wherein the pharmacy management module manages a plurality of past and present communications with the pharmacies and a plurality of medication records of the patients.

5. The computer-implemented system of claim 1, wherein the medical reconciliation application running on the server enables the patients to receive accurate treatment continuum from the clinics and the pharmacies based on the plurality of past and present clinical and medication information of the patients.

6. The computer-implemented system of claim 1, wherein the pharmacy management module of the medical reconciliation application allows the plurality of pharmacies to deliver medications to the patients prior to hospital discharge.

7. The computer-implemented system of claim 1, wherein the pharmacy management module of the medical reconciliation application enables the plurality of pharmacies to communicate with the patients through audio and video chats.

8. The computer-implemented system of claim 1, wherein the payment module of the medical reconciliation application enables the users to perform the online transactions with the plurality of clinics and the pharmacies.

9. The computer-implemented system of claim 1, wherein the medical reconciliation application running on the server provides a plurality of profiles for each of the users including patient profile, family profile, caretaker profile and a plurality of user defined profiles for managing a plurality of features of the medical reconciliation application.

10. The computer-implemented system of claim 1, wherein the medical reconciliation application running on the server communicates with a plurality of third party services including a plurality of healthcare insurance services for managing a plurality healthcare insurance related information of the patients.

11. The computer-implemented system of claim 1, wherein the medical reconciliation application accessible from the electronic devices is in communication with the server and allows the users to manage a plurality of clinical and medication information including dosage information and drug availability information for the patients.

12. The computer-implemented system of claim 1, wherein the medical reconciliation application running on the server and accessible from the electronic devices allow the users to receive a plurality of disease related information of the patients through the interactive user interface of the medical reconciliation application.

13. The computer-implemented system of claim 1, wherein the medical reconciliation application running on the server and accessible from the electronic devices provides a plurality of alerts to the patients for medication and related activities.

14. The computer-implemented system of claim 1, wherein the medical reconciliation application running on the server and accessible from the electronic devices ensure proper pharmacotherapy of the patients and minimizes a plurality of prescribing errors.

15. A computer-assisted method for comprehensive clinical and medication reconciliation of a patient includes the steps of:
determining a membership status of the patient in a medical reconciliation application for managing a plurality of clinical and medication information of the patients,
wherein the medical reconciliation application for managing the plurality of clinical and medication information of the patients is configured to run on a server and is accessible from a plurality of electronic devices over a wireless communication channel;
registering the patient in the medical reconciliation application by providing the plurality of clinical and medication information;
wherein the plurality of clinical and medication information includes the past and present medication list of the patient obtained from the patient and/or persons associated with the patient;
receiving a present medication list of the patient through the medical reconciliation application accessed from the electronic device,
wherein the medical reconciliation application runs on the server and is configured to be accessible from the plurality of electronic devices;
allowing a primary care physician and/or a pharmacist to review the present medication list of the patient,
wherein the medical reconciliation application allows the primary care physician and/or the pharmacist to get the present medication list of the patient reviewed from a referring health care facility;
verifying the past and present medication list of the patient from the patient and/or persons associated with the patient and updating the present medication list;
creating a best possible medication history (BPMH) of the patient and document the BPMH in a standardized form presented through an interactive user interface of the medical reconciliation application;
submitting the BPMH in a medical profile of the patient associated with the medical reconciliation application; and
enabling consultation with the primary care physician and/or the pharmacist on a plurality of updates to the medical profile of the patient.

16. The computer-assisted method of claim 15, wherein the comprehensive clinical and medication reconciliation of the patient further includes the steps of:
comparing an initial admission medication order for the patient with the BPMH of the patient for identifying any discrepancies;
identifying a plurality of intentional and non-intentional discrepancies in the initial admission medication order and the BPMH;
performing reconciliation of the discrepancies and revision of the initial admission medication order in case of non-intentional discrepancies;
documenting at least one intention for the discrepancy in a clinical record of the patient in case of intentional discrepancies;
allowing to contact a consulting physician using at least one communication method including texting or through electronic notifications; and
implementing an initial admission medication order for the patient using the medical reconciliation application running on the server and accessed from the electronic devices.

17. The computer-assisted method of claim 15, wherein the medical reconciliation application running on the server and accessible from the plurality of electronic devices enable real-time communication between a plurality of pharmacies and a plurality of hospitals and medical personnel.

18. The computer-assisted method of claim 15, wherein the medical reconciliation application enables the plurality of medical personnel to manage a plurality of medications and medication instructions of the patient remotely at the plurality of pharmacies,
wherein the plurality of pharmacies is implemented with the electronic device for running the medical reconciliation application.
